(19) United States
(12) Patent Application Publication
(10) Pub. No.: US 2004/0107270 A1
(43) Pub. Date: Jun. 3, 2004

(54) Method and system for collaboration recording

(76) Inventors: Jamie Stephens, Austin, TX (US); John Stockon, Austin, TX (US); John King, Austin, TX (US); Ken Kalinoski, Austin, TX (US)

Correspondence Address: Robert W. Holland, HAMILTON & TERRILE, LLP, PO Box 203518, Austin, TX, 78720, US

(21) Appl. No.: 10/694,157

(22) Filed: Oct. 27, 2003

Related U.S. Application Data
(60) Provisional application No. 60/422,336, filed on Oct. 30, 2002.

(51) Int. Cl. G06F 15/16

(52) U.S. Cl. 709/219; 709/205

(57) ABSTRACT

A collaboration archive recorder accepts information from plural media through a network and archives the information as a collaboration session having a temporal relationship between the stored media information for subsequent recreation of the collaboration. A media input interface accepts plural media types, such as audio, video, Web conferencing and application specific information, and provides the information to an archive engine for conversion to an archive format in which the information is related to each other by its presentation time during the collaboration. An archive output adapter presents all or selected portions of the collaboration session through a user interface that allows selection of archived information by content and the temporal relationship.

### RELATED APPLICATIONS

The present application claims priority from U.S. Provisional Patent Application Serial No. 60/422,366 entitled “Video Conferencing Device,” filed on Oct. 30, 2002, and incorporated herein by reference.

### BACKGROUND OF THE INVENTION

1. Field of the Invention

The present invention relates in general to the field of multimedia communications, and more particularly to a method and system for multimedia communications collaboration recording.

2. Description of the Related Art

People communicate using a wide variety of media including telephones, video conferences, Web conferencing, e-mail, instant messaging and other media. Businesses in particular have adapted to the proliferation of media for communication by encouraging employees to use the variety of available media as a relatively inexpensive alternative to travel. As a result, a growing number of business events ranging from sales calls to stockholder meetings are conducted at least in part through multimedia communications. For instance, a typical publicly held corporation's quarterly results release involves simultaneous use of a telephone conference call to which investors may listen by dial-in or through the Internet, a video conference for analysts to have direct interaction with corporate officials and documents like the quarterly report that are published electronically and shared with Web conferencing through a service such as WebEx. Web conferencing provides Web conferencing to exchange information with applications. Similarly configured conferences also occur in educational and governmental functions, such as seminars on educational topics cooperatively held by distant campuses or public hearings to weigh the impact of proposed laws or investigate events of public concern. Often these conferences include e-mail or instant message formats for submitting questions and concerns.

Often sponsors and participants in multimedia communications are required or desire to archive the information that is exchanged across the various media used in a given conference. Archiving is often desired and sometimes required so that information exchanged in a conference may be subsequently reviewed, with the archived documents ranging from the initial invitation to the final comments and having a wide variety of formats. For instance, Security and Exchange Commission rules often require businesses to archive certain communications such as stockholder meetings and quarterly results announcements. Even when not required, businesses often desire archiving to have a clear record of public communications in order to minimize the risk of litigation. Similarly, government bodies that have public hearings are often required to archive communications by various “sunshine” rules and sometimes desire to archive communications to have a historical accounting for rules and laws that are passed or investigations that are completed. In academia, archiving of communications during seminars provides an educational tool of specific presentations available for use in classrooms to teach associated topics. Often, archived seminars offer a starting point for subsequent research on topics associated with the seminar's subject matter.

Archiving of multimedia communications is generally a haphazard process that relies on the subjective judgments of the individual or individuals charged with archiving duty and is restricted by the technical limitations faced in the integration of media from a variety of sources and vendors. Mature media, such as phone and e-mail communications, generally have systems that support archiving on a media-by-media basis, however archiving support for newer media is scarce and often improvised. For instance, video conferences can be archived by connecting a VCR to an endpoint of the video conference and making a tape of the conference as it occurs. If the endpoint associated with archiving fails or has an interrupted signal, the archive is incomplete. Even if the video tape captures the complete conference as presented at the endpoint, other multimedia information is typically not included, such as presentations exchanged with Web conferencing and communications to speakers through e-mail or instant messages. A complete archive of a video conference that uses other communication media generally requires separate archiving for each media with no guarantee that the archive made will capture all desired information. Further, it is often difficult if not impossible to recreate a multimedia communication from disjointed recordings of the various media used to communicate information. For example, references by a speaker to exhibits are often too vague to re-capture without additional information as to the identity of the exhibit.

### SUMMARY OF THE INVENTION

Therefore a need has arisen for a method and system which archives multimedia collaborations.

A further need exists for a method and system which re-creates a multimedia collaboration in an organized and complete manner.

In accordance with the present invention, a method and system are provided which substantially reduce the disadvantages and problems associated with previous methods and systems for archiving multimedia communications. A collaboration archive recorder system accepts information from plural media associated with a collaboration performed through a network and stores the information in a session that temporally relates the information of the plural media over the duration of the collaboration. All or selected portions of the stored session are retrieved and presented by their temporal relationship to replay desired portions of the collaboration.

More specifically, the collaboration archive recorder system accepts information from plural media of a network collaboration through a media input interface, such as video, audio structured event and application specific media. The media input interface provides the information to an archive engine which formats the information for storage as a session having a temporal relationship over the duration of the collaboration. The collaboration session is stored in an archive and retrieved in whole or in part with an archive output adapter that replays selected portions of the collaboration. A temporal engine relates media information so that subsequent retrieval of one type of archived media information is aided by indexing to other types of archived media information. For instance, Web conferencing media having separate pages is temporally related to audio or video media by page number to allow subsequent retrieval of archived audio or video explanations that relate to each page of a presentation. In one embodiment, users interact with the archive engine to enter bookmarks for subsequent retrieval of media information associated with the entry of the bookmark. In another embodiment, a transcript of audio information is provide by a speech recognition engine and applied to generate a temporal map of the speakers in the collaboration.

The present invention provides a number of important technical advantages. One example of an important technical advantage is that multimedia collaborations are archived through a common platform in a simple and complete manner. The media input adapter provides an extensible interface so that the collaboration recorder system adapts to accept each type of media information involved in a collaboration in the same manner as collaboration participants. Real-time communication of each of plural media types of information results in automated real-time temporal association of the plural media streams in a collaboration session archive with relatively little administrative overhead.

Another example of an important technical advantage of the present invention is that archived collaborations are stored and re-created in an organized and complete manner. Subsequent retrieval of archived collaboration sessions may recall any selected or all media to re-create the collaboration as initially presented or may recall selected media portions by temporal association. For instance, an instructor may play back an archived seminar collaboration including the video, audio, Web conferencing presentation and e-mail questions presented at the seminar, as a learning tool for a class. Alternatively, a researcher may review specific audio comments made during presentation of a particular page of a Web conferencing presentation. Participants of a collaboration may identify specific portions of interest for subsequent review with bookmarked comments or may identify areas of interest by relation to transcribed remarks to archived media information. Annotations in the archive provides useful information to identify desired subject matter, such as meeting title, attendees, start and stop times, locations, media utilized, access control data (e.g., management eyes only), and a retention schedule that defines how long information is archived. Participants are provided with annotation ability based on approved access levels.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a networked collaboration archive recorder system;

FIG. 2 depicts a functional block diagram of a collaboration archive recorder; and

FIG. 3 depicts an example of a temporal display of an archived collaboration session.

### DETAILED DESCRIPTION

Archiving of multimedia communications is simplified through a centralized collaboration archive recorder system that accepts as inputs plural types of media and stores the media with a temporal relationship to allow re-creation of all or selected portions of an archived collaboration. The collaboration archive recorder interfaces as a client to each media of a collaboration to ensure complete and accurate archiving of each media's information without coordination by administrative personnel. A temporal relationship established between the media allows indexing of information from each media with each other and with added information, such as bookmarks or speaker information generated by transcription or voice recognition. Reliable archiving of networked collaborations aids in compliance with legal requirements and provides a useful and searchable record of training or educational programs.

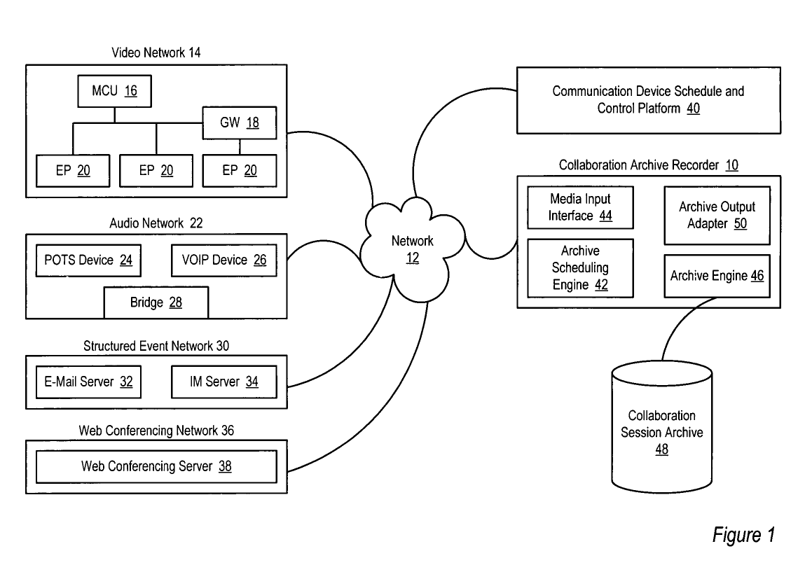

Referring now to FIG. 1, a block diagram depicts a collaboration archive recorder 10 interfaced through a network 12 with a variety of communications devices for archiving networked collaborations. A video network 14 includes MCU's for coordinating communication between endpoints 20 and a gateway 18 that bridges devices having different protocols, such as H.320 and H.323. An audio network 22 includes Plain Old Telephone System (POTS) devices 24, Voice Over Internet Protocol (VoIP) devices 26 and bridge devices 28 that supports conferences between plural audio endpoints. A structured event network 30 includes an e-mail server 32 and an instant messenger server 34 for communicating structured event e-mails and instant messages. A shared applications network 36 includes a shared Web conferencing server or service 38 that shares information between clients displayed in applications like POWERPOINT or WORD.

A communication device schedule and control platform 40, such as the Alliance Media Manager platform available from Forgent Networks, Inc., interfaces with communications devices of the various networks through network 12 to schedule and initiate collaborations. For instance, communication device schedule and control platform 40 may schedule a combined video and audio conference supported by e-mail and a shared POWERPOINT presentation. At the scheduled time, an MCU 16 initiates contact with video endpoints 20, audio bridge 28 and shared application server 38 so that participants may communicate by video, audio and share application exchanges of information. An e-mail address is made available to the participants for the exchange of questions and comments through e-mail server 32. In order to record an archive of the collaboration, communication device schedule and control platform 40 schedules and initiates contact with collaboration archive recorder 10 as a client for each type of media used in the collaboration. For instance, collaboration archive recorder 10 is scheduled by selection of an archive option during configuration of the communications devices for the collaboration.

Collaboration archive recorder 10 schedules archiving resources with an archive scheduling engine 42. Archive scheduling engine 42 reserves media input interface 44 for scheduled inbound contacts or initiates outbound contacts at desired times. For instance, in a combined video and audio conference, archive scheduling engine 42 reserves a video interface in media input interface 44 for contact initiated by MCU 16 at the scheduled collaboration time, and initiates contact by an audio interface in media input interface 44 to a bridge 28 to accept audio communications. If an MCU 16 is not required, then the endpoints themselves can communicate directly with their peers. An archive engine 46 receives information from each of the plural media communicating through media input interface 44 and saves the information with a temporal relationship that supports re-creation of the collaboration as it is received. The collaboration is saved as a temporally related session in collaboration session archive 48. An archive output adapter 50 recalls all or selected portions of a collaboration session archive for re-creation at a personal computer or through network 12.

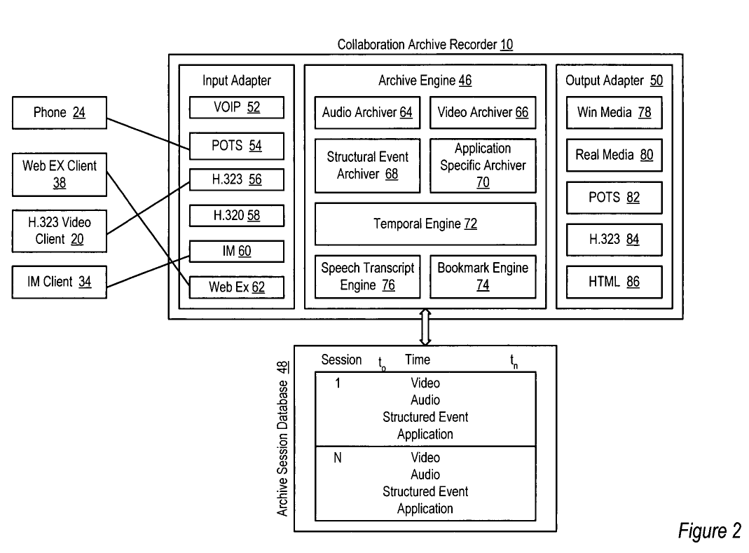

Referring now to FIG. 2, a functional block diagram depicts plural media providing information to archive as a collaboration session by collaboration archive recorder 10. Media input adapter 44 includes modules to interface with plural media, including a VoIP module 52, POTS module 54, H.323 module 56, H.320 module 58, instant message module 60 and Web conferencing service module 62. Media input interface 44 is extensible in that additional input media are supportable by addition of an appropriate module for communication with the media. In the example depicted by FIG. 2, a phone device 24 provides audio media information to POTS module 54, a Web conferencing service client 38 provides Web conferencing media information to Web conferencing service module 62, a H.323 video client 20 provides video media information to H.323 module 56 and an instant message client 34 provides instant message media information to instant message module 60. The information received at media input adapter 44 is communicated to archive engine 46 for formatting into desired storage formats. As an example, an audio archiver 64 accepts audio media, such as inputs through a POTS or VoIP interface and converts the input media to a common compressed audio format, such as WAV files, for storage in archive database 48. Video archiver 66 accepts video streams and converts the video streams to one or more popular compressed video protocols, such as MPEG, for storage in archive database 48. Structured event archiver 68 converts e-mail and instant message communications into HTML pages, and application specific archiver 70 converts specific documents in certain application formats, such as POWERPOINT and WORD documents, to popular display formats, such as HTML or Adobe PDF formats.

Various media of a collaboration are archived to collaboration session database 48 for subsequent re-creation of the collaboration as the collaboration took place. A temporal engine 72 tracks the time of each media archiver output and ensures that each output is archived in a common session with a time reference that tracks the relationship between the media. For instance, a video conference that includes a POWERPOINT presentation through a WebEx interface is archived with a time reference to the various pages of the presentation. A bookmark engine 74 allows participants of the collaboration to bookmark events through the duration of the collaboration so that the participant may later return to the time of the bookmark for review of the collaboration at that time. A speech transcript engine 76 transcribes audible speech received in the collaboration and relates the transcription to the media so that subsequent review of the transcript aids in location of archived media without re-creation of the complete collaboration. In one embodiment, voice recognition of audible speech permits a time chart of speakers.

Once a collaboration session is archived, output adapter 50 recreates all or selected portions of the collaboration for replay at a personal computer or transmission through a network. For instance, WinMedia module 78, Real Media module 80 and HTML module 86 recreate video, audio and presentation information for replay on a personal computer. A POTS module 82 allows an authorized individual to call into collaboration archive recorder 10 and listen to audio archive through a telephone and a H.323 module 84 allows an authorized individual to call into collaboration archive recorder 10 to view video archives through a video endpoint. All or just selected portions of the collaboration may be re-created as desired.

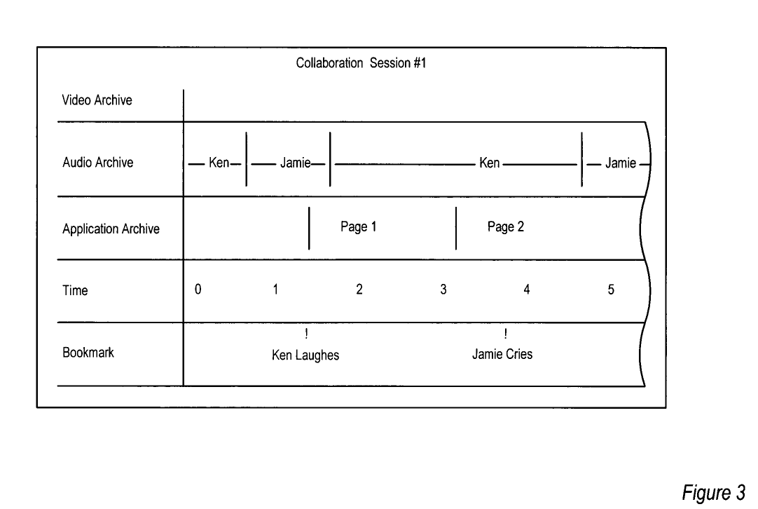

Referring to FIG. 3, an example of a display of an archived collaboration session is depicted. A user re-creates selected portions of the archived collaboration by pointing to the selected portions with a mouse. The audio archive illustrates a speaker map generated by voice recognition so that the user may identify portions of the archive of interest based on the identity of the speaker. The application archive illustrates the time during which particular pages of a presentation were shown during the collaboration so that a user may re-create the collaboration for documents of interest. A bookmark time line illustrates bookmarks entered by the user to identify points in the collaboration of interest, such as by remarks entered regarding the events. Selective re-creation of desired information improves the efficiency of accesses to the archived collaboration by allowing the user to restrict the review to areas of interest, such as documents or comments associated with documents, without requiring the user to review substantial portions of the archive itself.

Although the present invention has been described in detail, it should be understood that various changes, substitutions and alterations can be made hereto without departing from the spirit and scope of the invention as defined by the appended claims.

What is claimed is:

1. A system for archiving a collaboration over a network, the collaboration having plural media, the system comprising:
an input adapter operable to accept each media of the collaboration over a network interface;
an archive engine operable to accept the plural media of the collaboration from the input adapter and to format the plural media of the collaboration for storage as a session that temporally relates the plural media over the duration of the collaboration;
an archive database operable to store the session; and
an output adapter operable to retrieve an archived session for replay of the collaboration.

2. The system of claim 1 further comprising a scheduling engine operable to schedule the input adapter for communication with the plural media of the collaboration.

3. The system of claim 1 further comprising a bookmark engine interfaced with the archive engine and operable to set temporal bookmarks in the session, wherein the output adapter is further operable to retrieve an archived session for replay at a bookmark.

4. The system of claim 1 further comprising a speech recognition engine interfaced with the archive and operable to convert audio media into a transcript.

5. The system of claim 4 wherein the speech recognition engine is further operable to provide a temporal map of speaker identity over the duration of the collaboration.

6. The system of claim 1 wherein the plural media comprises a visual presentation having plural pages and wherein the archive engine is further operable to associate other media of the session with a page of the presentation.

7. The system of claim 1 wherein the archive engine comprises:
an audio engine operable to format audio information for archiving;
a video engine operable to format video information for archiving;
a structured events engine operable to format structured events for archiving;
an application specific engine operable to format application specific information for archiving; and
a temporal engine operable to temporally relate archived information as a session.

8. A method for archiving a network collaboration having plural media, the method comprising:
interfacing with the network to receive the plural media;
formatting each of the plural media for storage as a temporally related session that relates each media over the duration of the collaboration;
storing the session in an archive database; and
retrieving all or selection portions of the stored session for replay of the collaboration.

9. The method of claim 8 wherein the plural media comprise audio, video and application specific media.

10. The method of claim 9 wherein the application specific media comprise a shared application document.

11. The method of claim 8 wherein the plural media comprise structured events media.

12. The method of claim 11 wherein the structured events media comprises instant messages.

13. The method of claim 11 wherein the structured events media comprises e-mail.

14. The method of claim 8 wherein interfacing with the network further comprises initiating communication with an archive engine as an endpoint of the collaboration.

15. The method of claim 8 further comprising:
inserting a bookmark into the session to provide a temporal reference; and
retrieving the archived session at the temporal reference with the bookmark.

16. The method of claim 8 further comprising:
transcribing audio media of the collaboration; and
storing the transcribed audio media in the archive temporally related to the audio media.

17. The method of claim 16 further comprising:
identifying voices associated with the transcribed audio media; and
visually depicting the identified voices along a time line of the collaboration.

18. The method of claim 17 wherein retrieving selected portions further comprises retrieving portions of the collaboration associated with a temporal voice identification.

19. The method of claim 8 further comprising:
associating temporal display of a document during the collaboration with contemporaneous information of one or more of the plural media; and
indexing in the archive the temporal display of the document and the contemporaneous information of the one or more plural media.

20. The method of claim 19 wherein retrieving selected portions further comprises retrieving the document and the indexed contemporaneous information of the one or more plural media.

21. The method of claim 20 wherein the indexed contemporaneous information comprises audio information.

22. The method of claim 20 wherein the indexed contemporaneous information comprises video information.
